(19) United States
(12) Patent Application Publication
(10) Pub. No.: US 2021/0322258 A1
(43) Pub. Date: Oct. 21, 2021

(54) SEXUAL AID APPARATUS WITH SAFETY DEVICE

(71) Applicant: Brendan Miner, St. Augustine, FL (US)

(72) Inventor: Brendan Miner, St. Augustine, FL (US)

(21) Appl. No.: 17/360,633

(22) Filed: Jun. 28, 2021

Related U.S. Application Data
(63) Continuation-in-part of application No. 15/982,650, filed on May 17, 2018, now Pat. No. 11,065,177.

(51) Int. Cl. A61H 19/00; A61H 23/02; A61H 21/00

(52) U.S. Cl. CPC A61H 19/44; A61H 2201/0173; A61H 21/00; A61H 23/02

(57) ABSTRACT

A sexual aid apparatus with a safety feature includes a shaft element configured to emulate a human penis and to be placed against genitals or inside a human orifice, the shaft element comprising a truncated conical tip at a proximal end and a hollow interior; an electric vibrating motor located within the shaft element, the electric vibrating motor configured for vibrating the shaft element so as to produce sensation in a user when used against genitals or inside a human orifice; a cap located at a distal end of the shaft element, the cap including a U-shaped element that is integrally formed with the cap; and a flexible cord coupled to the U-shaped element, the cord configured for having a tensile strength of at least 20 pounds per square inch.

### CROSS-REFERENCE TO RELATED APPLICATIONS

This patent application is a continuation in part of patent application Ser. No. 15/982,650 filed on May 17, 2018, entitled “Sexual Aid Apparatus with Safety Device.” The subject matter of patent application Ser. No. 15/982,650 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to human safety and, more specifically, to safety devices used with sexual aid apparatuses.

### BACKGROUND

Sexual aid devices, otherwise known as sex toys, have enjoyed increasing sales in recent years. What was considered a nascent industry only a few years ago, has now grown into a 15 billion worldwide industry, with projections of a 30 billion worldwide industry by 2020. The increase in the rate of growth of the sex toy industry has been attributed to a variety of factors, including more relaxed views on sex, the growing popularity of vibrators for therapeutic purposes, the rapid growth of e-commerce, an increase in the lesbian population, as well as other societal factors. Regardless of the causal factors, there is an increase in the availability of sex toys among the population, and a corresponding increase in the use of sex toys by men and woman alike.

The use of sex toys, however, comes with certain risks. A common risk associated with the use of prosthetic penises, or dildos, for example, is the inadvertent impaction of the toy within a human orifice, such as the anus. Rectal foreign bodies, as they are called, are well known in the medical literature and are a common affliction treated in emergency rooms worldwide. It is known that most patients presenting with a rectal foreign body can be treated in the emergency room. That is, the rectal foreign body can be removed transanally in the emergency room. If the patient does not cooperate due to discomfort or pain during the procedure, however, repetitive attempts to removing the rectal foreign body may be necessary. This might result in the rectal foreign body being shifted deeper into the anal canal or in anal sphincter damage. In such cases, anesthesia may be applied to the patient before continuing attempts. In cases where the rectal foreign body is very large or complications (such as rectal perforation or peritonitis) are found, a proctocolectomy or an enterostomy through a laparotomy might be necessary. In more complicated cases, spinal or pudendum anesthesia may be required. After removal of the rectal foreign body, the patient is often observed for a period of time in case of complications such as delayed damage caused by the rectal foreign body.

Needless to say, the impaction of a sexual aid device within a human orifice, such as the anus, can be painful, dangerous, and harmful to human health. Unfortunately, there are few, if any, safety devices currently available that prevent impaction of a sexual aid device or aid in its removal in the event of an impaction.

Therefore, a need exists for improvements over the prior art, and more particularly for devices and processes for improving the safety of sex toys.

### SUMMARY

A sexual aid apparatus for reducing or eliminating inadvertent impaction of the apparatus within a human orifice is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the apparatus includes a shaft element configured to emulate a human penis and to be placed against genitals or inside a human orifice, the shaft element comprising a truncated conical tip at a proximal end and a hollow interior; an electric vibrating motor located within the shaft element, the electric vibrating motor configured for vibrating the shaft element so as to produce sensation in a user when used against genitals or inside a human orifice; a cap located at a distal end of the shaft element, the cap including a U-shaped element that is integrally formed with the cap; and a flexible cord coupled to the U-shaped element, the cord configured for having a tensile strength of at least 20 pounds per square inch.

### BRIEF DESCRIPTION OF THE DRAWINGS

The claimed subject matter is particularly pointed out and distinctly claimed in the claims at the conclusion of the specification. The foregoing and other features and also the advantages of the claimed subject matter will be apparent from the following detailed description taken in conjunction with the accompanying drawings. Additionally, the left most digit of a reference number may identify the drawing in which the reference number first appears. The accompanying drawings, which are incorporated in and constitute a part of this disclosure, illustrate various example embodiments. In the drawings:

FIG. 1 is an illustration of a prosthetic penis sexual aid apparatus;

FIG. 2 is an illustration of a safety device used with the prosthetic penis sexual aid apparatus, according to a first example embodiment;

FIG. 3 is an illustration of a safety device combined with the prosthetic penis sexual aid apparatus, according to the first example embodiment;

FIG. 4 is an illustration of the safety device combined with the prosthetic penis sexual aid apparatus, according to a second example embodiment;

FIG. 5 is an illustration of the safety device combined with the prosthetic penis sexual aid apparatus, according to a third example embodiment;

FIG. 6 is an illustration of the safety device for use with the prosthetic penis sexual aid apparatus, according to the third example embodiment;

FIG. 7 is another illustration of the safety device for use with the prosthetic penis sexual aid apparatus, according to the third example embodiment;

FIG. 8 is an illustration of the interior components of the safety device for use with the prosthetic penis sexual aid apparatus, according to the first, second and third example embodiments.

FIG. 9 is an elevated side view illustration of an alternative embodiment of the prosthetic penis sexual aid apparatus, according to a first example embodiment;

FIG. 10 is a top view illustration of an exemplary shaft element, according to the first example embodiment;

FIG. 11 is a bottom view illustration of the shaft element, according to the first example embodiment;

FIG. 12 is an upper perspective view illustration of the shaft element, according to the first example embodiment;

FIG. 13 is a sectioned side view illustration of the prosthetic penis sexual aid apparatus, according to the first example embodiment;

FIG. 14 is a sectioned sideview illustration of an exemplary housing for the prosthetic penis sexual aid apparatus, according to a second example embodiment;

FIG. 15 is a top view illustration of the housing for the prosthetic penis sexual aid apparatus, according to the second example embodiment;

FIG. 16 is a bottom view illustration of the housing for the prosthetic penis sexual aid apparatus, according to the second example embodiment;

FIG. 17 is a perspective view illustration of the housing for the prosthetic penis sexual aid apparatus, according to the second example embodiment;

FIG. 18 is an elevated side view illustration of an exemplary electric vibratory motor and battery, according to a third example embodiment;

FIG. 19 is a top view illustration of the electric vibratory motor and battery, according to a third example embodiment;

FIG. 20 is a bottom view illustration of the electric vibratory motor and battery, according to a third example embodiment;

FIG. 21 is a perspective view illustration of the electric vibratory motor and battery, according to a third example embodiment;

FIG. 22 is an elevated side view illustration of an exemplary cap and exemplary one or more battery fitting elements, according to a fourth example embodiment;

FIG. 23 is a top view illustration of the cap and the one or more battery fitting elements, according to the fourth example embodiment;

FIG. 24 is a top view illustration of an exemplary cap and exemplary U-shaped element, according to a fifth example embodiment;

FIG. 25 is a perspective view illustration of the cap and the U-shaped element, according to the fifth example embodiment;

FIG. 26 is an exploded view illustration of the alternative embodiment of the prosthetic penis sexual aid apparatus, according to a sixth example embodiment; and

FIG. 27 is a perspective illustration of an exemplary cord tied to the U-shaped element at the distal end of the shaft element, according to a seventh example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The disclosed embodiments improve over the prior art by providing a simple and easy-to-use safety device for use with a sexual aid apparatus, such that impaction of the apparatus within a human orifice may be prevented or undone. The disclosed safety device reduces or eliminates the possibility that the sexual aid apparatus becomes impacted during use and further, if impaction does occur, the impaction can be removed using the safety device. The features of the disclosed embodiments further decrease the possibility of bodily harm occurring in a user that experiences impaction. The disclosed embodiments also reduce or eliminate that more complicated procedures are necessary when removing an impaction. The disclosed embodiments also improve over the prior art by providing a simplified mechanism for removing an impacted sexual aid apparatus if impaction occurs. This feature increases the chances that the use can remove an impaction himself, if impaction does occur, without requiring medical assistance.

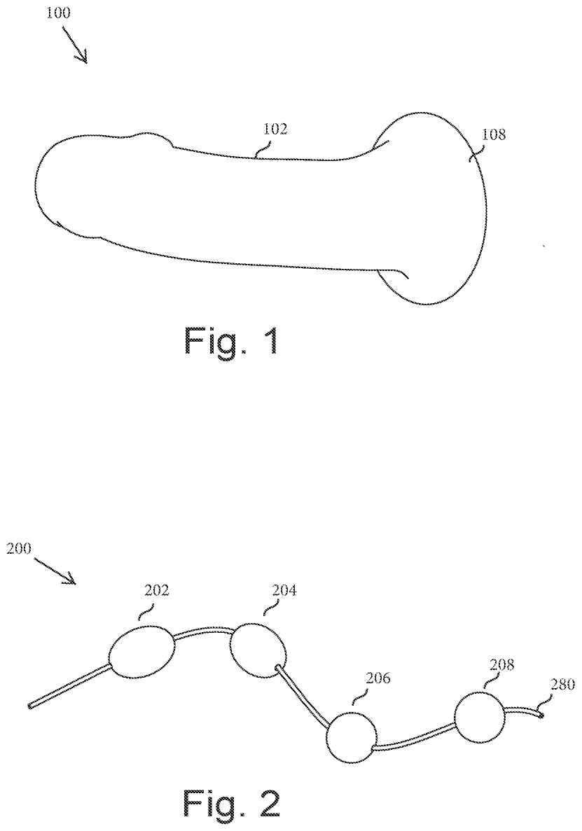

FIG. 1 is an illustration of a prosthetic penis sexual aid apparatus 100. The apparatus 100 is an apparatus that is well known in the art and can be referred to as a dildo. A dildo is an apparatus usually designed for penetration of the vagina, mouth, or anus, and is usually solid and phallic in shape. Such apparatuses can be used by people of all genders and sexual orientations, for masturbation or for other sexual activity. Dildos can be manufactured from a variety of different materials, including rubber, silicone, PVC, jelly rubber, plastic, steel, metal, glass, borosilicate glass, and cyberskin (a type of thermoplastic sex toy material that is composed of a variety of elements and feels like human skin). The apparatus 100 may also include an anti-bacterial layer or covering that features anti-bacterial qualities.

The prosthetic penis sexual aid apparatus 100 may include an electric vibrating motor located within the shaft element, the electric vibrating motor configured for vibrating the shaft element so as to produce sensation in a user when used against male or female genitals or inside a human orifice, such as a vagina, mouth, or anus.

The prosthetic penis sexual aid apparatus 100 may include a shaft element 102, which may emulate a human penis and is configured (in size, shape, composition, width, length, elasticity, texture, and color) to be placed against male or female genitals or inside a human orifice, such as a vagina, mouth, or anus. The prosthetic penis sexual aid apparatus 100 may also include a base 108, which may have an outer diameter that is larger than the outer diameter of the shaft 102.

FIG. 2 is an illustration of a safety device 200 used with the prosthetic penis sexual aid apparatus 100, according to a first example embodiment. The safety device 200 includes a flexible cord 280 configured to be coupled to a distal end of the prosthetic penis sexual aid apparatus 100 or the shaft element 102. The cord 280 is configured for having a tensile strength of at least 20 pounds per square inch or psi. 1 psi is approximately equal to 6895 N/m². Alternatively, the cord 280 is configured for having a tensile strength of at least 10 psi, 30 psi, 40 psi and 50 psi.

The safety device 200 includes one or more spherical elements 206, 208 coupled to the cord 280 and located between ends of the cord, the spherical elements configured for insertion into a human orifice and for producing sensation in the user. The one or more spherical elements 206, 208 may include an electric vibrating motor located within the elements, the electric vibrating motor configured for vibrating the spherical elements so as to produce sensation in a user when used against male or female genitals or inside a human orifice, such as a vagina, mouth, or anus. The one or more spherical elements 206, 208 may be coupled to the cord via a bore in each spherical element, through which the cord extends.

The safety device 200 includes one or more crystal elements 202, 204 coupled to the cord 280 and located between the ends of the cord, the crystal elements configured for insertion into a human orifice and for producing sensation in the user. The crystal elements 202, 204 may be ellipsoid shaped or spherical shaped and may be composed of a crystal comprising solid material whose constituents are arranged in a highly ordered microscopic structure, forming a crystal lattice that extends in all directions. Crystals are often used in pseudoscientific practices such as crystal therapy, and, along with gemstones, are sometimes associated with religious movements. The crystal elements 202, 204 may also be composed of gemstones, which are pieces of mineral crystal that are polished. Examples of gemstones are turquoise, hematite, quartz, jasper, malachite, ruby, pyrite, etc. Certain rocks (such as lapis lazuli, opal, and jade) or organic materials that are not minerals (such as amber, jet, and pearl) are also often considered to be gemstones as well. The one or more crystal elements 202, 204 may be coupled to the cord via a bore in each spherical element, through which the cord extends.

FIG. 3 is an illustration of the safety device 200 combined with the prosthetic penis sexual aid apparatus 100, according to the first example embodiment 300. FIG. 3 shows that a proximal end of the cord 280 of the safety device 200 is coupled to a distal end (specifically, the base 108) of the prosthetic penis sexual aid apparatus 100. This arrangement allows the user to pull on the cord 280 in a distal direction, either to remove the prosthetic penis sexual aid apparatus 100 if it has become impacted, or to prevent the prosthetic penis sexual aid apparatus 100 from being impacted in a human orifice.

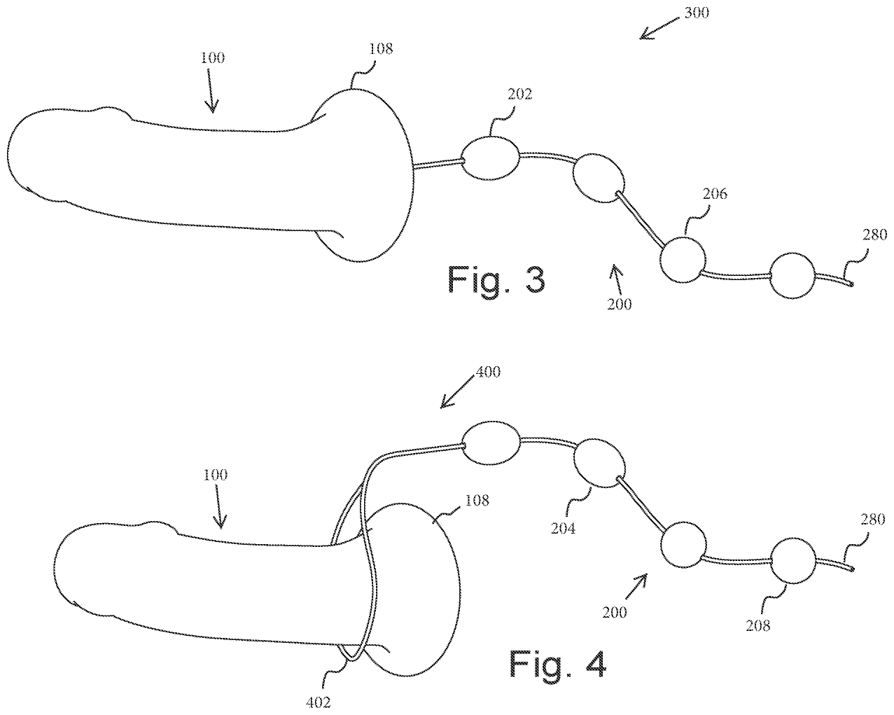

FIG. 4 is an illustration of the safety device 200 combined with the prosthetic penis sexual aid apparatus 100, according to a second example embodiment 400. FIG. 3 shows that a proximal end of the cord 280 of the safety device 200 comprises a loop or knot 402 that surrounds the distal end (specifically, the base 108) of the prosthetic penis sexual aid apparatus 100. The loop or knot 402 may be configured to tighten when the cord 280 is pulled in the distal direction, such as a slipknot. Recall the prosthetic penis sexual aid apparatus 100 may include a base 108, which may have an outer diameter that is larger than the outer diameter of the shaft 102. This prevents the loop or knot 402 of the cord 280 from slipping off the sexual aid apparatus 100 if the cord is pulled distally. Again, this arrangement allows the user to pull on the cord 280 in a distal direction, either to remove the prosthetic penis sexual aid apparatus 100 if it has become impacted, or to prevent the prosthetic penis sexual aid apparatus 100 from being impacted in a human orifice.

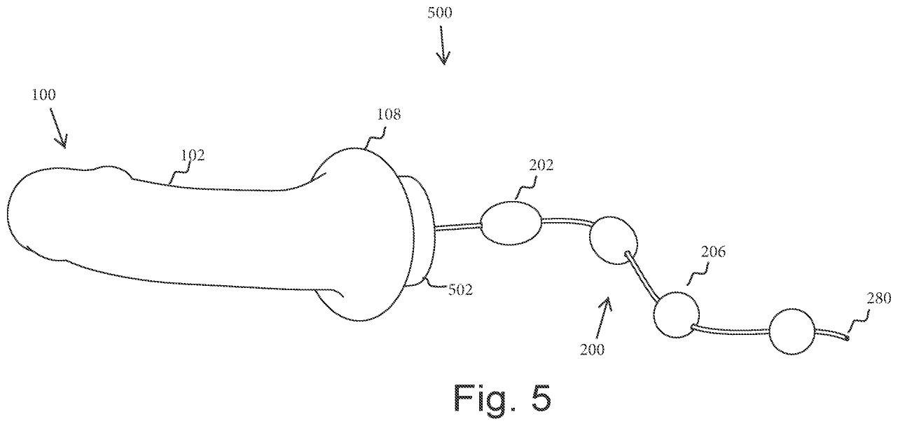

FIG. 5 is an illustration of the safety device 200 combined with the prosthetic penis sexual aid apparatus 100, according to a third example embodiment 500. FIG. 5 shows that a proximal end of the cord 280 of the safety device 200 is coupled to a distal end (specifically, a cap 502) of the prosthetic penis sexual aid apparatus 100. The cap 502 may be a removable cover that provides access to an inner volume within the sexual aid apparatus 100, wherein said inner volume may be a battery compartment, a compartment to access a vibrating motor or other compartment within the sexual aid apparatus 100. Again, this arrangement allows the user to pull on the cord 280 in a distal direction, either to remove the prosthetic penis sexual aid apparatus 100 if it has become impacted, or to prevent the prosthetic penis sexual aid apparatus 100 from being impacted in a human orifice.

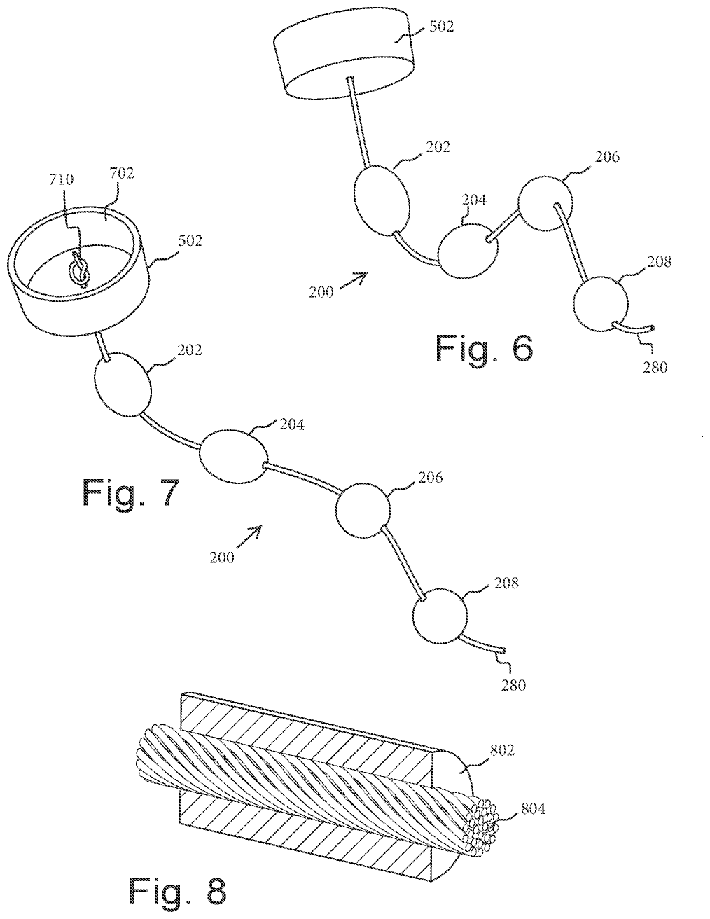

FIG. 6 is an illustration of the safety device 200 for use with the prosthetic penis sexual aid apparatus 100, according to the third example embodiment. FIG. 6 shows that the distal end of the cord 280 has been attached to the cap 502, which is, in turn, is coupled to the distal end of the sexual aid apparatus 100, such as the base 108.

FIG. 7 is another illustration of the safety device 200 for use with the prosthetic penis sexual aid apparatus 100, according to the third example embodiment. FIG. 7 shows that the distal end of the cord 280 has been attached to the cap 502, which is, in turn, is coupled to the distal end of the sexual aid apparatus 100, such as the base 108. The cap 502 may be a cylindrical shaped object that has an inner surface 702 that is threaded such that the cap may be threaded or screwed onto an outer surface of the distal end of the sexual aid apparatus 100, such as the base 108. In one embodiment, there is an orifice in the flat round surface of the cap 502, though which the cord 280 extends. Thereby, a knot 710 is tied in the end of the cord 280, so as to prevent the cord 280 from being removed from the cap 502 when the cord is pulled in the distal direction.

FIG. 8 is an illustration of the interior components of the safety device 200 for use with the prosthetic penis sexual aid apparatus 100, according to the first, second and third example embodiments. The cord 280 may comprise a rope constructed with its interior core 804 protected by a rubber or plastic sheath 802 designed to optimize strength, durability, cleanliness, elasticity, softness, and flexibility. The core fibers 804 provide the tensile strength of the cord 280, while the sheath 802 protects the core from debris, unclean material, and abrasion during use. The sheath also protects the user from being scratched or otherwise marred by the core fibers 804. The cord 280 may be dynamic for greater elasticity or static.

In one embodiment, the safety device 200 and sexual aid apparatus 100 may be utilized with a disposable vacuum seal plastic pouch configured for surrounding and sealing at least the shaft element 102 of the sexual aid apparatus 100, the pouch configured for form-fitting at least the shaft element and for removal from said shaft element after use. This arrangement amounts to the sexual aid apparatus 100 being vacuum packed. Vacuum packing is a method of packaging that removes air from the package prior to sealing. This method involves placing the sexual aid apparatus 100 in the disposable vacuum seal plastic pouch, removing air from inside, and sealing the pouch. Shrink film may be used to form fit to the sexual aid apparatus 100.

Vacuum packing reduces or eliminates the possibility of bacteria, unclean material or debris coming into contact with the sexual aid apparatus 100 during use. After use, the pouch may be disposed of, and a new pouch used for a new session of use. Vacuum packing can also be used to store the sexual aid apparatus 100, so as to protect the apparatus from bacterial growth, debris, or other unclean material.

Devices 100 and 200 and their components may be manufactured from a variety of materials including rubber, plastic, metal, such as stainless steel, titanium, aluminum or any metal alloy, rigid fabric, carbon fiber, epoxy resin, graphite, or any combination of the above. Devices 100 and 200 and their components may also be manufactured from a synthetic man-made material.

Plastic covers a range of synthetic or semi-synthetic polymerization products. Plastics are composed of organic condensation or addition polymers and may contain other substances to improve performance or economics. Plastic may comprise any one of the following forms of plastic: polyethylene, polystyrene, high impact polystyrene, polyethylene terephthalate, nylon, polypropylene, acrylonitrile butadiene styrene (ABS), bayblend and polyvinylidene chloride (PVC).

Devices 100, 200 and their components may be manufactured from a plastic compound using any variety of processes, such as injection molding, fusible core injection molding and thermoforming.

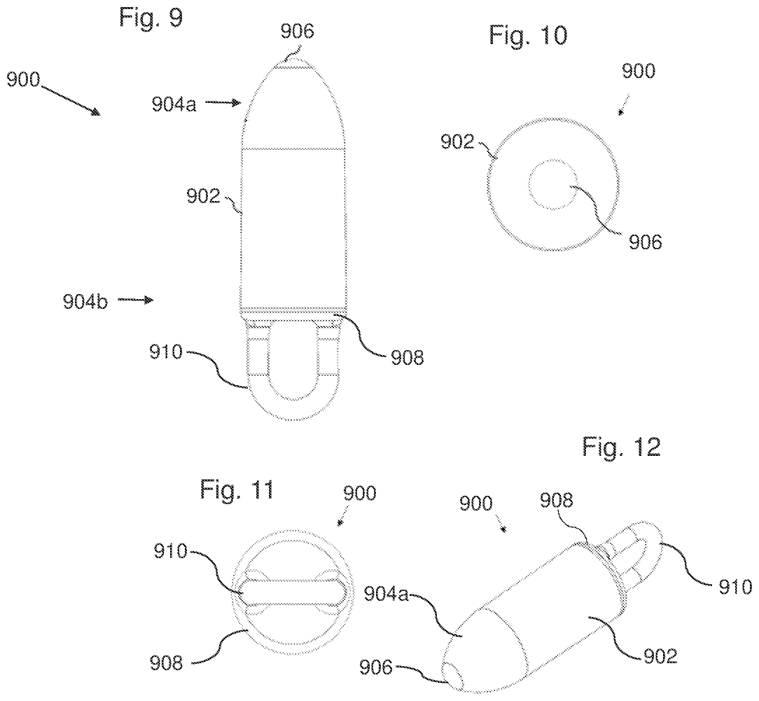

FIG. 9 is an elevated side view illustration of an alternative embodiment of a prosthetic penis sexual aid apparatus 900. The prosthetic penis sexual aid apparatus 900, hereafter “apparatus 900” is unique in providing a shaft element 902 that engages the genitals and/or penetrates the human orifice as a manual force is applied in the form of sexually oriented, linear, lateral, rotational, and vibrational motions designed to produce sexual pleasure in the genitals and the human orifice. The apparatus 900 provides an electric vibrating motor 1308 for further enhancement of the sexual stimulation. The apparatus 900 also includes an off-center weight 1310 situated within a housing 1302 inside the shaft element 902. The off-center weight 1310 is part of the electric vibrating motor 1308 and causes a vibrating motion when rotated. Additionally, a silicon layer 1314 encapsulates the housing 1302.

In some embodiments, the apparatus 900 comprises a shaft element 902 that emulates a human penis (see FIG. 9). The shaft element 902 is the primary structure that engages the genitals and human orifice. In some embodiments, the shaft element 902 has a proximal end 904a and an opposing distal end 904b. The proximal end 904a terminates at a truncated conical tip 906, which is narrower than the distal end 904b. In one embodiment, the conical tip 906 is pointed to facilitate sexual stimulation at the genitals, and penetration of the human orifice. FIG. 10 show how the truncated conical tip 906 is shaped and dimensioned to be placed against genitals or inside a human orifice.

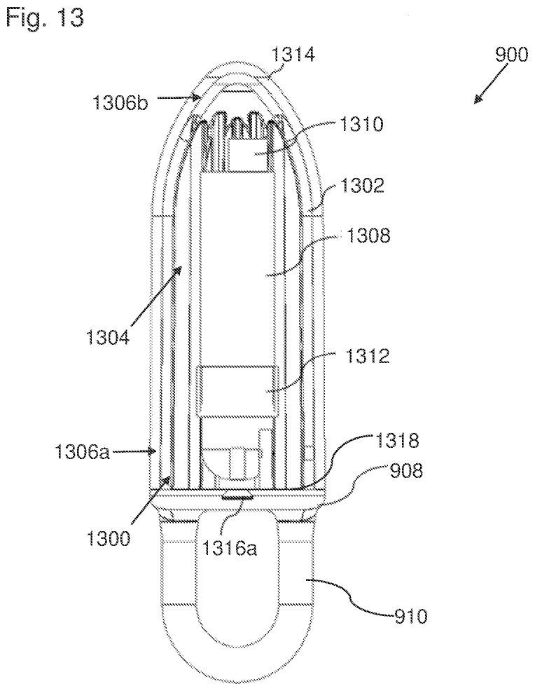

As discussed below, the opposing distal end 904b of the shaft element 902 has a cap 908 that supports a U-shaped element 910 (see FIGS. 11-12). The shaft element 902 also defines a hollow interior 1300 that creates sufficient volume to contain the electrical and mechanical components of the apparatus 900 (FIG. 13).

Located inside the hollow interior 1300 of the shaft element 902 is a housing 1302. The housing 1302 forms substantially the same shape as the shaft element 902, but with a smaller diameter and length (see FIG. 17). The housing 1302 is at least partially in contact with the inner surface of the shaft element 902, such that there is mechanical coupling therebetween. Further, the housing 1302 defines a cavity 1304 that provides a snug compartment for electrical components.

Also similar to the shaft element 902, the housing 1302 defines a distal end 1306a that orients towards the distal end 904b of the shaft element 902, and a proximal end 1306b that orients towards the proximal end 904a of the shaft element 902. The proximal end 1306b of the housing 1302 may have a smaller diameter than the distal end 1306a so as to better conform to the shape of the shaft element 902.

As discussed below, the housing 1302 is displaced in substantially the same motion and speed as the linear and lateral displacement, and rotation of the shaft element 902. That is, as the shaft element 902 is displaced in such a manner, the housing 1302 moves accordingly. For example, if the shaft element 902 is displaced in an axial, back-and-forth motion, the housing 1302 follows. Or if the shaft element 902 vibrates, the housing 1302 also vibrates at approximately the same intensity.

Looking ahead to FIG. 16, the housing 1302 contains an electric vibrating motor 1308. Those skilled in the art will recognize that sexually oriented toys and devices often utilize vibratory mechanisms to enhance the sexual pleasure in and around the genitals and human orifices. Thus, the electric vibrating motor 1308 may include a small, motor that operates through electrical power, and has various electrical components, i.e., circuit, wiring, resistors.

In any case, the electrical configuration of the electric vibrating motor 1308 requires electrical current to operate. Such electrical power may originate from a simple D/C power source, such as a battery 1312. In one non-limiting embodiment, the electric vibrating motor 1308 is a direct power brush motor, or an electric induction motor with squirrel cage rotor. However, other types of electrical motors may also be used.

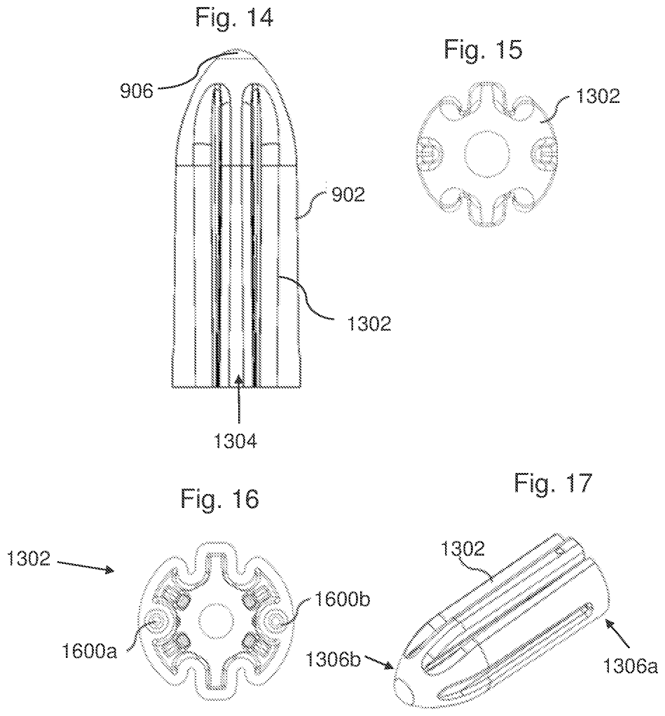

The electric vibrating motor 1308 is located within the cavity 1304 of the housing 1302, in a generally central disposition along the longitudinal of the housing 1302 (see FIG. 14). In this position, the electric vibrating motor 1308 is inherently mechanically coupled to both the housing 1302 and shaft element 902 (FIG. 15). This position allows the electric vibrating motor 1308 to cause the shaft element 902 to vibrate for sexual satisfaction of the user.

In this manner, the electric vibrating motor 1308 vibrates the shaft element 902, so as to produce sensation in a user when used against genitals or inside a human orifice. In one possible embodiment, a power switch, and a speed switch (not shown) operatively connect to the electric vibrating motor 1308 for regulating power and speed of the vibrations, respectively.

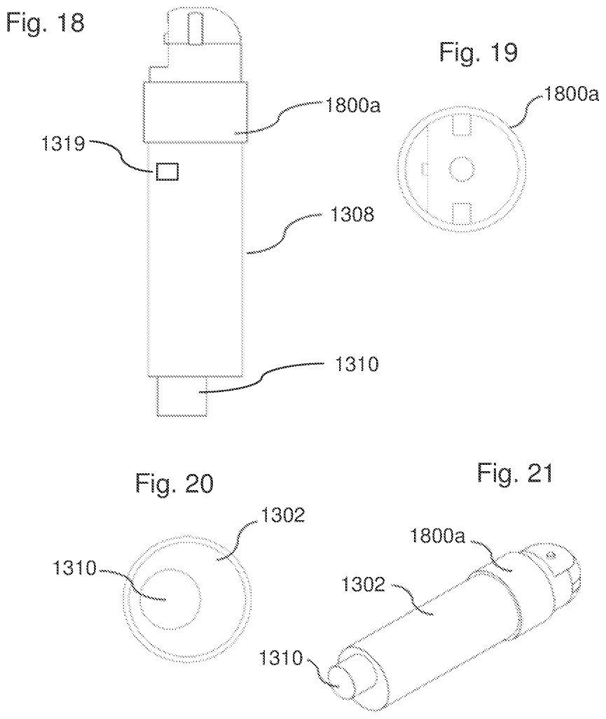

Turning now to FIG. 18, the apparatus 900 also includes an off-center weight 1310 that is part of the electric vibrating motor 1308. Those skilled in the art will recognize that an off-center weight 1310 is a device that vibrates when rotated.

The user may control vibrating functions of the device 900, such as on, off, increase vibration and decrease vibration functions, using a mobile application executing on a mobile computing device. The device 900 may include a radio frequency communication chip 1319 that is able to communicate via radio frequency with a mobile computing device. A Bluetooth chip is one example of a radio frequency communication chip 1319. The user may control functions of the device 900 by interacting with widgets on a touch display screen (such as sliders, pull down menus, buttons, and text fields) of a mobile application executing on a mobile computing device. This alternative reduces or eliminates the necessity for buttons or switches on the device 900. In addition to said functions, the mobile application may also provide status data, such as the amount of battery power left on the device 900, how long it would take to recharge both the battery of the device 900, how long the device has been used, etc. The mobile application may also be linked to a website to reorder said device 900. The mobile application may also allow the user to control the magnitude of vibration of the device 900.

As shown in FIG. 19 the off-center weight 1310 is located within the cavity 1304 of the housing 1302, adjacent to the electric vibrating motor 1308. In this disposition, the off-center weight 1310 is configured to mechanically couple to the shaft element 902. In this relationship, substantially all the motion of the shaft element 902 in any direction, speed, and intensity translates to the off-center weight 1310. In one embodiment, the shaft element 902 displaces linearly and laterally relative to the off-center weight 1310. The shaft element 902 also rotates the off-center weight 1310. Other possible movements of the shaft element 902 can include oscillating motion that rotate the off-center weight 1310.

In some embodiments, a silicon layer 1314 encapsulates and seals the housing 1302 (see FIG. 13). The silicon layer 1314 operates to make the device easier to clean and maintain hygienic.

As FIG. 20 illustrates, the apparatus 900 may also provide a battery 1312 for powering the electric vibrating motor 1308. The battery 1312 is located within the cavity 1304 of the housing 1302, and operatively connected to the electric vibrating motor 1308 through wires, circuits, and battery 1312 poles known in the art. In some embodiments, the battery 1312 is charged with electrical charge with an electric charger that is well known in the art. The electrical power provided by the battery 1312 powers the electric vibrating motor 1308.

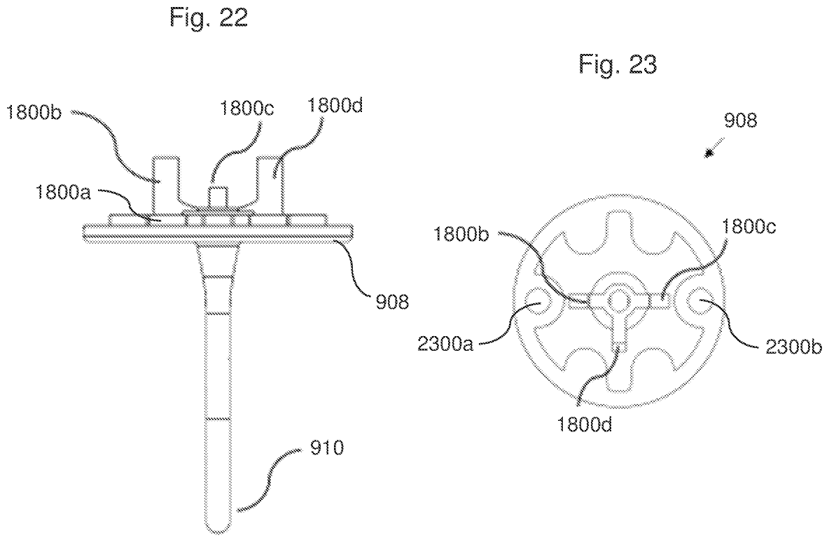

Looking at FIG. 22, the apparatus 900 also provides one or more battery fitting elements 1800a-d configured to maintain the battery 1312 in mechanical attachment with the off-center weight 1310. The one or more battery 1312 fitting elements can include a ring 1800a that holds multiple spaced-apart prongs 1800b-d arranged in a circular pattern and oriented perpendicular to the cap 908 (see FIG. 23).

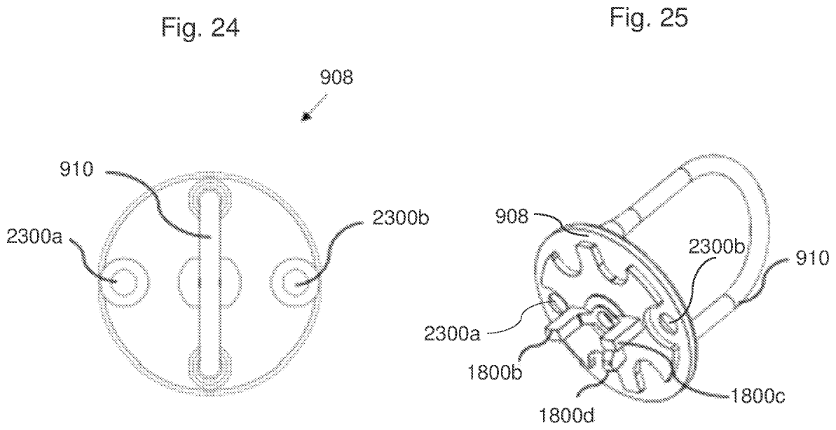

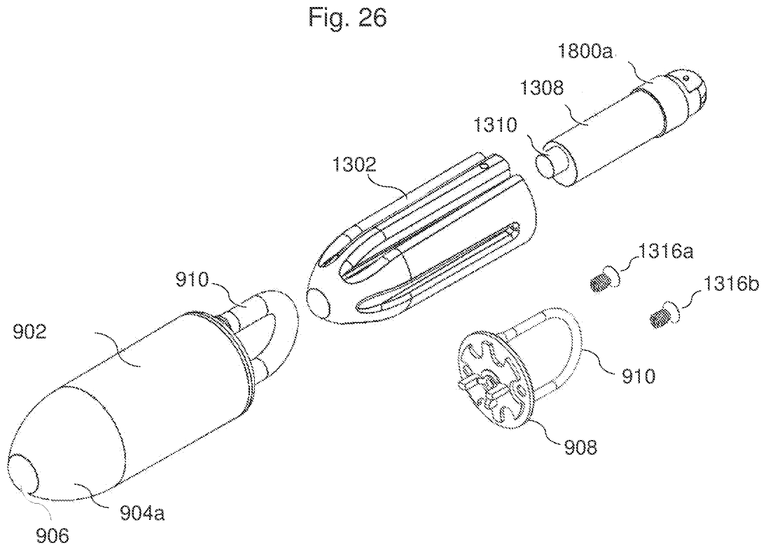

Looking now at FIG. 24, the terminus of the shaft element 902, at the distal end 904b, comprises a cap 908. The cap 908 is a useful component that serves the dual purpose of sealing the hollow interior of the shaft element 902 and providing a structural mount that enables a cord 2700 to pull on the shaft element 902. As shown in FIG. 25, the cap 908 may have a cylindrical shape to match the cylindrical shape of the shaft element 902.

The cap 908 may also have an inner surface 1318 that is threaded such that the cap 908 may be screwed onto an outer surface of the distal end 904b of the shaft element 902. In one embodiment, multiple screw holes 1600a, 1600b in the housing 1302 are adapted to align with corresponding screw holes 2300a, 2300b in the cap 908. The screw holes 1600a-b. 2300a-b are sized and dimensioned to enable multiple screws 1306 to fasten the housing 1302 to the shaft element 902.

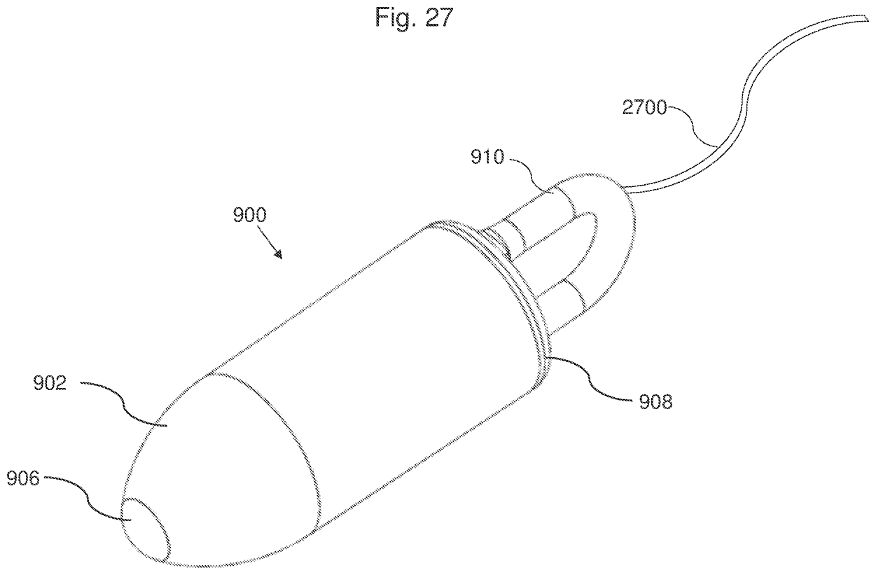

In some embodiments, there is U-shaped element 910 that is integrally formed with the cap 908, though which a cord 2700 may extend, or to which a cord 2700 is attached. In alternative embodiments, the U-shaped element 910 may have a square, rectangular, triangular, or irregular shape. In any case, a knot may be tied in the end of the cord 2700 or the cord may attach directly to the U-shaped element (see FIG. 27). This helps prevent the cord 2700 from being removed from the cap 908 when the cord 2700 is pulled in the distal direction for disengaging the shaft element 902 from the genitals and/or removing the shaft element 902 from the human orifice. In some embodiments, the cord 2700 is a flexible cord.

In operation, the shaft element 902 is oriented, such that a proximal end faces the genital, or human orifice. A truncated conical tip 906 at the proximal end helps enhance stimulus at the genitals and penetrate the human orifice. The opposing distal end is held firmly. And a cord is tied around the U-shaped element 910 thereon. The cord is flexible, which helps in pulling the shaft element 902 from the human orifice and manipulating the shaft element 902 from the distal end.

Next, an axial force is applied to the distal end of the shaft element 902 in order to abut the conical tip 906 against the genital or introduce the conical tip 906 into the human orifice. The shaft element 902 may then be manually manipulated in an axial, lateral, or rotational direction to achieve sexual stimulation. Additionally, an electric vibrating motor 1308, located in the cavity 1304 of the housing 1302, is powered on to enhance the stimulative effect.

As the shaft element 902 is manipulated in such a manner, the movements are transferred to the housing 1302. The battery powers the electric vibrating motor 1308; directly through a wire connection to the electric vibrating motor 1308. Additionally, a silicon layer 1314 on the housing 1302 serves to translate the linear displacement and the rotation of the off-center weight 1310 to the user. After finishing, the cord is pulled in an axial direction to remove the shaft element 902 from the genital or human orifice.

While certain embodiments have been described, other embodiments may exist. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A sexual aid apparatus with a safety feature, the apparatus comprising:
(a) a shaft element configured to emulate a human penis and to be placed against genitals or inside a human orifice, the shaft element comprising a truncated conical tip at a proximal end and a hollow interior;
(b) an electric vibrating motor located within the shaft element, the electric vibrating motor configured for vibrating the shaft element so as to produce sensation in a user when used against genitals or inside a human orifice;
(c) a cap located at a distal end of the shaft element, the cap including a U-shaped element that is integrally formed with the cap; and
(d) a flexible cord coupled to the U-shaped element, the cord configured for having a tensile strength of at least 20 pounds per square inch.

2. The sexual aid apparatus of claim 1, further comprising:
a rubber layer configured for surrounding and sealing the shaft element and cap of the sexual aid apparatus.

3. The sexual aid apparatus of claim 2, further comprising:
one or more spherical elements coupled to the cord and located between ends of the cord, the spherical elements configured for insertion into a human orifice and for producing sensation in the user.

4. The sexual aid apparatus of claim 3, further comprising:
one or more crystal elements coupled to the cord and located between the ends of the cord, the crystal elements configured for insertion into a human orifice and for producing sensation in the user.

5. The sexual aid apparatus of claim 4, wherein the flexible cord is coupled to the U-shaped element via a loop that surrounds the U-shaped element.

6. The sexual aid apparatus of claim 5, wherein the flexible cord comprises a core fiber surrounded by a rubber sheath.

7. The sexual aid apparatus of claim 5, wherein the one or more spherical elements are coupled to the cord such that the cord extends through a bore in each of the one or more spherical elements.

8. The sexual aid apparatus of claim 6, wherein the one or more crystal elements are coupled to the cord such that the cord extends through a bore in each of the one or more crystal elements.

9. A sexual aid apparatus with a safety feature, the apparatus comprising:
(a) a shaft element configured to emulate a human penis and to be placed against genitals or inside a human orifice, the shaft element comprising a truncated conical tip at a proximal end and a hollow interior;
(b) a housing disposed inside the hollow interior of the shaft element, the housing defining a cavity;
(c) an electric vibrating motor located within the cavity of the housing, the electric vibrating motor configured for vibrating the shaft element so as to produce sensation in a user when used against genitals or inside a human orifice;
(d) an off-center weight coupled to the electric vibrating motor, wherein the off-center weight produces a vibrating force that vibrates the shaft element when the off-center weight is rotated by the electric vibrating motor;
(e) a cap located at a distal end of the shaft element, the cap including a U-shaped element that is integrally formed with the cap; and
(f) a flexible cord coupled to the U-shaped element, the cord being operable to enable pulling the shaft element out of the human orifice and disengaging the shaft element from against the genitals.

10. The sexual aid apparatus of claim 9, further comprising:
a battery located within the cavity of the housing, the battery being charged by an external power source.

11. The sexual aid apparatus of claim 9, further comprising:
a silicon layer configured for surrounding and sealing the housing.

12. The sexual aid apparatus of claim 9, further comprising:
one or more battery fitting elements configured to maintain the battery in mechanical attachment with the vibrating motor.

13. The sexual aid apparatus of claim 12, wherein the one or more battery fitting elements comprise multiple spaced-apart prongs arranged in a circular pattern and oriented perpendicular to the cap.

14. The sexual aid apparatus of claim 9, wherein the housing defines a distal end oriented towards the distal end of the shaft element, and a proximal end oriented towards the proximal end of the shaft element.

15. The sexual aid apparatus of claim 14, wherein the distal end of the housing forms multiple screw holes adapted to align with corresponding screw holes in the cap, the screw holes operable to enable multiple screws to fasten the housing to the shaft element.
